(19) United States
(12) Patent Application Publication
(10) Pub. No.: US 2012/0030013 A1
(43) Pub. Date: Feb. 2, 2012

(54) SLIDESHOWS IN SEARCH

(76) Inventors: Caroline Tsay, Palo Alto, CA (US); Marc Davis, San Francisco, CA (US); Anuj Sahai, Bangalore (IN); Anja Krombholz, San Francisco, CA (US); Polly Ng, Forest Hills, NY (US); Aaron Wheeler, San Francisco, CA (US); Anand Ramani, Bangalore (IN)

(21) Appl. No.: 12/844,517

(22) Filed: Jul. 27, 2010

(51) Int. Cl. G06F 3/048; G06Q 30/00

(52) U.S. Cl. 705/14.49; 715/730

(57) ABSTRACT

Techniques are provided to allow users to access interested information without performing engaging searches. A content-providing system may track collective interests of a large set of users and/or individual interests of a user. User-selectable items may be presented to the user directly without the user performing searches. Some of the user-selectable items may be associated with slideshows that are, for example, pre-deposited or curated to provide interesting information relating to these user-selectable items. The user may easily access a slideshow and the content therein using easily comprehensible controls presented on a display page.

### TECHNICAL FIELD

Embodiments relate generally to content presentation, and, more specifically, to techniques for engaging users to view interesting information.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Frequently, users may casually visit webpages without performing any engaging searches to proactively discover interesting information that might be accessible from the webpages they visited. Users may find the process of explicitly searching for interesting information among a plethora of information resources tedious, marginal and time-consuming. Users may even be unaware that there may be information of interest readily discoverable beneath the surface. Even if some limited searches are made, users may find that results are dispersed among many uninteresting information items, and appear disorganized and only sporadically useful.

One approach to overcoming these and other problems is for the content provider to guess what may be interesting to a user. Unfortunately, this approach is labor intensive, unreliable, and error-prone, especially when the users are light users of a website.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A and FIG. 1B illustrate example system configurations that may be used to provide content under techniques described herein;

FIG. 2A and FIG. 2B illustrate example display pages one or both of which may be personalized for a user based on the user's profile;

FIG. 3A, FIG. 3B and FIG. 3C illustrate an example repository that stores user-selectable items and slideshows, an example slideshow, and an example content item in a slideshow;

FIG. 4A and FIG. 4B illustrate two example display pages from which slideshows may be accessed;

FIG. 5 illustrates an example process flow; and

FIG. 6 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1.0. General Overview

2.0. Structural Overview

3.0. Example Display Pages

4.0. Example Repository and Information Therein

5.0. Additional Example Display Pages

6.0. Example Process Flow

7.0 User Personalization

8.0 Monetization

9.0 Time Sensitivity

10.0 Implementation Mechanism—Hardware Overview

11.0 Extensions and Alternatives

### 1.0. General Overview

Approaches, techniques, and mechanisms are disclosed for providing slideshows to users. A content-providing system may select two or more user-selectable items among a plurality of items determined to be of interest to users. The plurality of items may comprise articles, passages, images, key words, etc. The plurality of items may be discovered and ranked by analyzing browsing and searching behaviors from a large group of users and determining occurrences and frequencies of user accesses involving the items. The two or more user-selectable items may be re-selected and re-ranked for a user based in part on a user profile associated with the user, and may be displayed on a display portion (or a piece of display real estate) of a display page. Subsequently, when the user makes a selection of a particular user-selectable item among the two or more user-selectable items, the content-providing system may receive an indication of such selection. The content-providing system may, in response, determine whether the particular user-selectable term is associated with a slideshow. In response that a determination that the particular user-selectable term is associated with a slideshow, an initial content item (e.g., slide) in the slideshow and one or more controls may be presented to the user. The user may navigate and access any of the content items in sequence or in another order using the provided controls. In one embodiment, such slideshow-navigating controls are not presented to the user except in response to a determination that an item that the user selected is, or refers to, a slideshow. In an embodiment, the two or more user-selectable items are continually displayed as the initial content item is displayed and as other content items in the slideshow are navigated to by the user through the controls.

In some embodiments, other parts of the display page other than the display portion may also be personalized for the user based on the user profile. In some embodiments, the two or more user-selectable items may be chosen and ranked by a personalization algorithm based in part on the user profile. For example, the user profile may comprise information derived from prior browsing and searching histories or feedbacks of the user.

In some embodiments, each content item in the slideshow comprises an imagery content component and a textual content component associated with the imagery content component. In an embodiment, the imagery content component is one of the following: videos, still photographic images, art images, or cartoons; however, in other embodiments, the imagery content may comprise some combination of these. In an embodiment, the textual content component may comprise a caption and a text passage.

In some embodiments, the display page is a webpage served by the content-providing system in the form of a website, while the two or more user-selectable items may be presented as a group of textual terms (e.g., keywords) on a display portion of the webpage.

In some embodiments, the slideshow is stored in a repository. The slideshow may be among a plurality of slideshows that can be accessed by a user using any of one, two, or more services provided by the content-providing system. In some embodiments, links to the services may be presented on the display page. For example, servers in the content-providing system that support a variety of services may use the same APIs to access the same slideshow in the repository.

In some embodiments, the slideshow may be among a plurality of slideshows that can be accessed by an external service provided by a different content-providing system. For example, an HTML link may be provided to the different content-providing system so that a user of the different content-providing system may access a slideshow in the repository.

In some embodiments, a slideshow described herein may comprise one or more advertisements. In some embodiments, at least one content item in the slideshow may be manually edited by a curator authorized to edit content provided on display pages of an operator that causes the display page to be displayed to the user.

In some embodiments, while the user-selectable items may be selected based in part on the user profile, a slideshow associated with a particular user-selectable item is not specifically associated with any user. The same slideshow will be displayed to any user when the particular user-selectable item is selected by the user. In some embodiments, the two or more user-selectable items may not be inputted by the user who calls up a slideshow associated with one of the user-selectable items.

In other aspects, the invention encompasses a system, a computer apparatus and/or a non-transitory computer-readable medium configured to carry out the foregoing steps.

### 2.0. Structural Overview

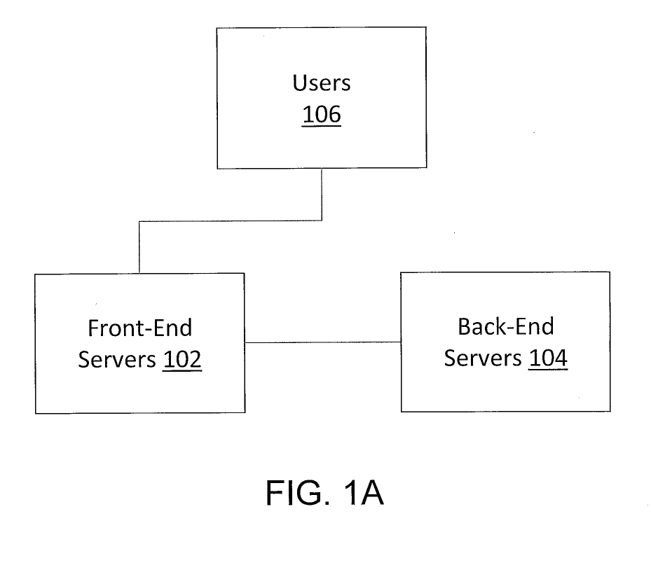

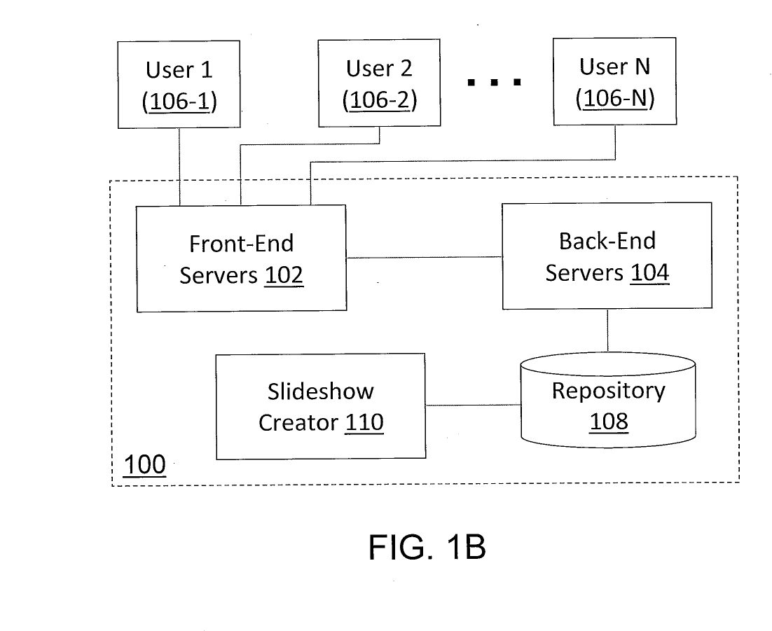

FIG. 1A is an example block diagram depicting users 106, one or more front-end servers 102 with which users 106 interact to obtain content there from, and one or more back-end servers 104 that are operatively linked with front-end servers 102 and are configured to work with the front-end servers to provide information to the users. Users 106 may interact with front-end servers 102 through one or more network connections. These network connections may be in the form of one or more of wired connections, wireless connections, optical connections, satellites, intranets, the Internet, LANs, WANs, home area networks, etc. As used herein, any of the users (106) may refer to a user of one or more computing devices; examples of the computing devices include, but are not limited to, personal computers, personal digital assistants, handheld devices, computer servers, TVs, game devices, computer clusters, etc. In some embodiments, users 106 may use browsing or searching applications, web browsers and/or client-side applications to interact (e.g., send and receive requests and responses) with front-end servers 102 and indirectly with the back-end servers 104 of FIG. 1A.

Through respective computing devices, users 106 may retrieve content from front-end servers 102. For example, a user may receive one or more webpages from front-end servers 102. These webpages may be produced by front-end servers 102 itself or in conjunction with other server including back-end servers 104.

As used herein, the term “front-end servers” may refer to one or more servers that are configured to directly interact with users 106 via network connections. Front-end servers 102 may include, but are not limited to, one or more of web servers, application servers, load-balancing servers, redirection servers, etc.

As used herein, the term “back-end servers” may refer to one or more servers that are operatively linked with one or more front-end servers and help the front-end servers provide content to users. Back-end servers 102 may include, but are not limited to, one or more of database servers, search engines, editorial server, application servers, servlet engines, etc.

In some embodiments, as illustrated in FIG. 1B, front-end servers 102 and back-end servers 104 may be part of a content-providing system 100. As used herein, the term “content-providing system” may refer to a system that is configured with one or more computing devices and that is configured to provide a variety of content to users 106. The variety of content may include, but is not limited to, personalized, parsed, pre-deposited, editorialized, curated, dynamic, static, and/or commercial information.

In some embodiments, the content-providing system 100 may additionally and/or optionally comprise a repository 108 with which the back-end servers 104 may perform operations such as storing, editing, deleting, and retrieving any in the variety of content.

As used herein, the term “repository” may refer to one or more logical or physical data stores that support one or more operations such as storing, editing, deleting, and retrieving information including slideshows and user profiles. Examples of repositories as described herein may be databases, file systems, storage devices, network storages, etc.

As used herein, the term “content” may refer to information that may be provided to a user. Content may include, but is not limited to, images, videos, advertisements, articles, search results, emails, product specifications, sound recordings, texts, logos, slideshows, key words, graphic and/or text-based user interface components, etc.

In some embodiments, the content-providing system 100 may additionally and/or optionally comprise a slideshow creator 110 which is configured to collect data from a variety of sources, analyze group behaviors of a large set of users in browsing and searching information, acquiring imagery, text data, establishing user-selectable items, creating slideshows that are associated with one, two, or more of the user-selectable items, selecting and incorporating advertisements in the slideshows. For the purpose of illustration, users 106 may be a set of individual users such as 106-1, 106-2, through 106-N. These users may interact with content-providing system 100 to various extents for the purpose of retrieving content of interest.

In some embodiments in which users 106 are internet users, slideshow creator 110 may collect hit counts of various web content and frequencies of search terms based on data collected from a large set of internet users. Slideshow creator 110 may create a set of candidate user-selectable items several times a day, periodically, on-demand, etc. In some embodiments, the set of candidate user-selectable items may all be text-based tokens. These text-based tokens may be, but are not limited to, names of personalities, events, geographic locations at which the events occur, keywords characterizing some pieces of interesting information. In some other embodiments, at least one item in the set of candidate user-selectable items may be non-text based. In these embodiments, a candidate user-selectable item may be, but is not limited to be, a thumbnail of a highly sought-after image, a memorable icon, a well-known mark, an easily recognized symbol, etc. In some embodiments, a candidate user-selectable item is established based on its occurrences, frequencies, and popularities as revealed by analyzing and following up in real time browsing and/or searching activities, of different groups of users, related to the candidate user-selectable item.

In some embodiments, slideshow creator 110 may compile a set of primary materials related to a candidate user-selectable item. Primary materials may be sourced from various data providers, affiliated news organizations, historical data, search results, etc. From the set of primary materials related to the candidate user-selectable item, most interesting and/or relevant and/or eyeball-catching imagery data may be selected. Examples of imagery data may be, but are not limited to, digital photographic images, audiovisual materials, artworks, cartoons, advertisements, inline captions, picture-in-pictures, or a combination thereof. Captions and text descriptions/passages may be created/generated for the imagery data. The data for the candidate user-selectable item may be collected, analyzed, created, and edited by slideshow creator 110 in order to generate or assemble a slideshow for the candidate user-selectable item. In some embodiments, slideshow creator 110 may store the slideshow and the candidate user-selectable item in repository 108.

In some embodiments, slideshow creator 110 may additionally and/or optionally comprise editorial tools to edit any information in the slideshow.

In some embodiments, as the content-providing system 100 is made aware of the fact that a user is accessing a display page, the content-providing system 100 may re-rank and re-select one, two, or more of the candidate user-selectable items for displaying on a display portion of the display page and for selection by the user. It should be noted that, in one embodiment, not all user-selectable items displayed to a user are connected with any slideshow. For example, some user-selectable items, when selected, may lead to search results, but not a slideshow. In some embodiments, a special icon may be displayed next to a user-selectable item that has a slideshow to indicate to a user that the user-selectable item has a slideshow and that the slideshow may be accessed, for example, by clicking on the special icon.

### 3.0. Example Display Pages

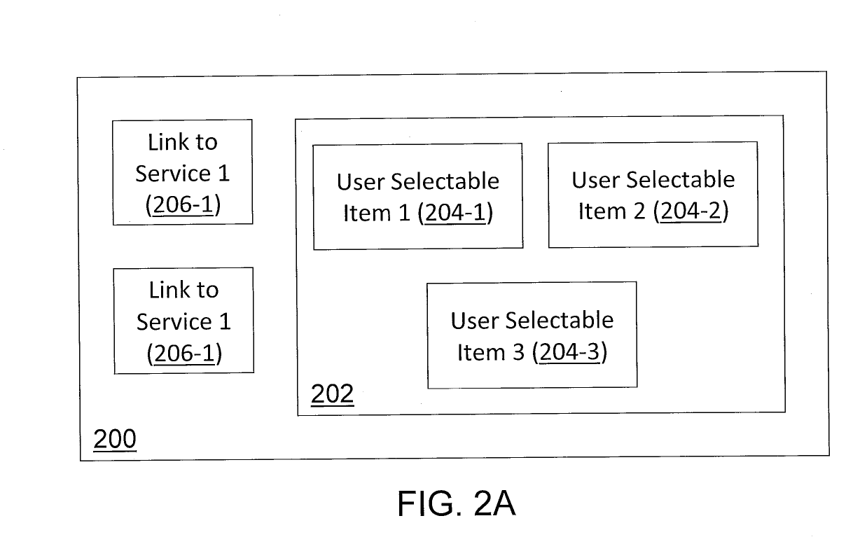

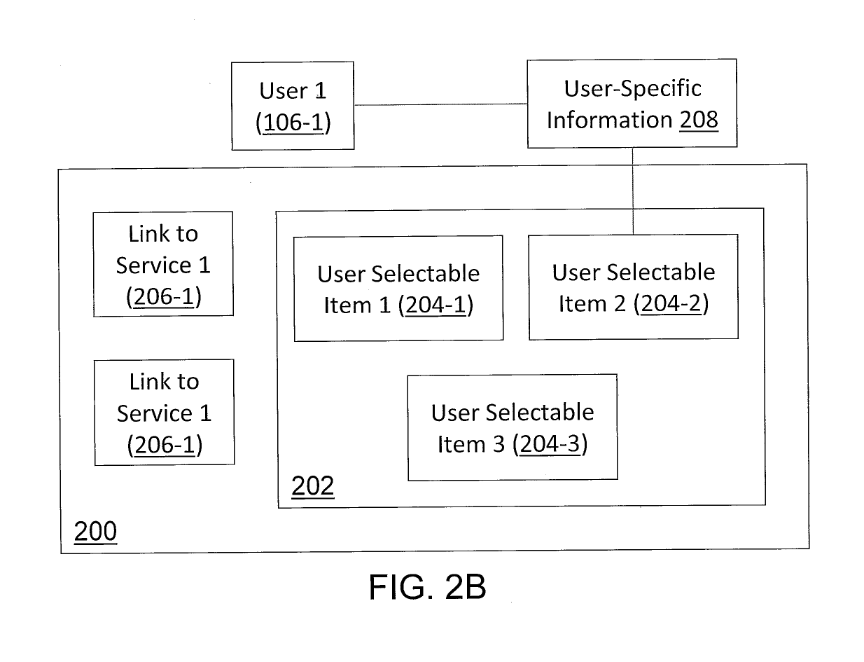

FIG. 2A illustrates an example display page 200 according to an embodiment of the present invention. A user (e.g., one of 106-1 through 106-N) may operate a client to access display page 200 provided by front-end servers 102. For example, the client which the user uses to access display page 200 may be a web browser that retrieves display page 200 over a network such as the Internet and presents display page 200 in the form of a webpage to the user, while front-end servers 102 may be web servers responsible for sending those webpages to the client.

In some embodiments, display page 200 may be a website landing page (or homepage) used by the user to access a plurality of services offered through a website. The plurality of services through the website may include finding information on this website, information on other websites, locating historical information and news, accessing and using an email account, following favorite stocks and financial news, reading stories and tidbits about celebrities and sportspersons, creating the user's individual webpages, shopping online, looking for jobs, making travel arrangements, buying real estate properties, doing online banking, sharing information with friends and acquaintances, storing files, scheduling meetings and making entries in calendars, searching for events, places, and people, etc. These services may be solely provided by an operator of the website, or conjunctively provided by the operator with other parties, or provided by one or more different parties external to the operator.

Display page 200 may comprise a plurality of display portions. In some embodiments, display page 200 may comprise a display portion (not shown) that provides one or more links to services accessible to the user from display page 200. For example, a display portion may comprise a link to service 1 (206-1), a link to service 2 (206-2), etc.

In some embodiments, display page 200 may comprise a display portion 202 that comprises one, two, or more user-selectable items such as user-selectable items 1 through 3 (204-1 through 3). In some embodiments, at least one component in display page 200 may be common, non-specific to any user. For example, display page 200 may be a landing page that displays links to all services provided by a website, no matter which user accesses the landing page. In some embodiments, at least one component, including any of user-selectable items, links to services, or other items included in display page 200 may be personalized for the user. As illustrated in FIG. 2B, display page 200 may be requested by and/or constructed for user 1 (106-1). In various embodiments, none, some, or all of the components provided in display page 200 may be customized/personalized for user 1 (106-1).

The content-providing system 100 may access a user profile 208 specific to user 1 (106-1) when handling a request from user 1 (106-1) for display page 200. In an embodiment, the user profile may be stored in repository 108 or another repository, and may be retrieved by the content-providing system 100 or a part therein (for example, one or more of the first or back-end servers 102 and 104). When user 1 (106-1) visits the website, the content-providing system 100 may establish a user identity for user 1 (106-1). For example, the content-providing system 100 may establish the user identity based on an account id or name of user 1 (106-1), and retrieve, based on the established user identity, a user profile 208. As used herein, “user profile” may refer to any user-specific information that has been developed by an operator of a website and may include prior searches made by an associated user, prior purchases, prior visits, prior activities, user-provided information, collected information specific to the user as from one or more internal or external information sources, etc.

In an embodiment as illustrated in FIG. 2B, at least one of user-selectable items 1 through 3 (204-1 through 204-3) are personalized for user 1 (106-1). A second user, for example, user 2 (106-2), when visiting a same-addressed landing page of the same website, may receive a different set of user-selectable items that is personalized based on a user profile of user 2 (106-2). In some embodiments, the user profile of user 2 (106-2) is different from the user profile of another user, for example, user 1 (106-1).

### 4.0 Example Repository and Information Therein

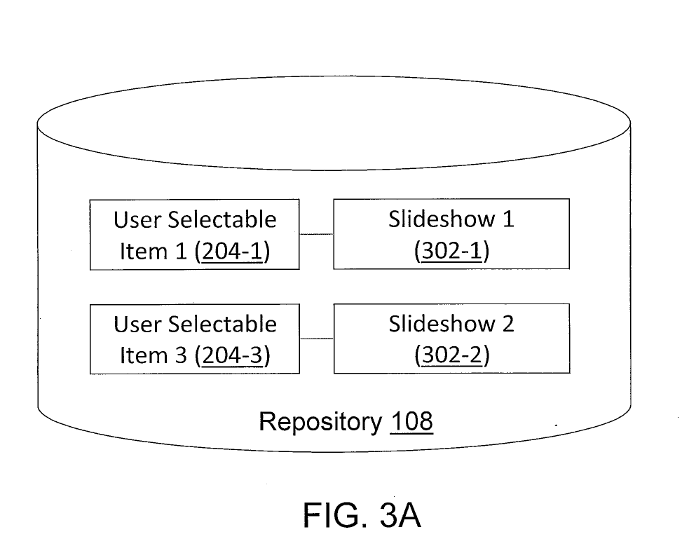

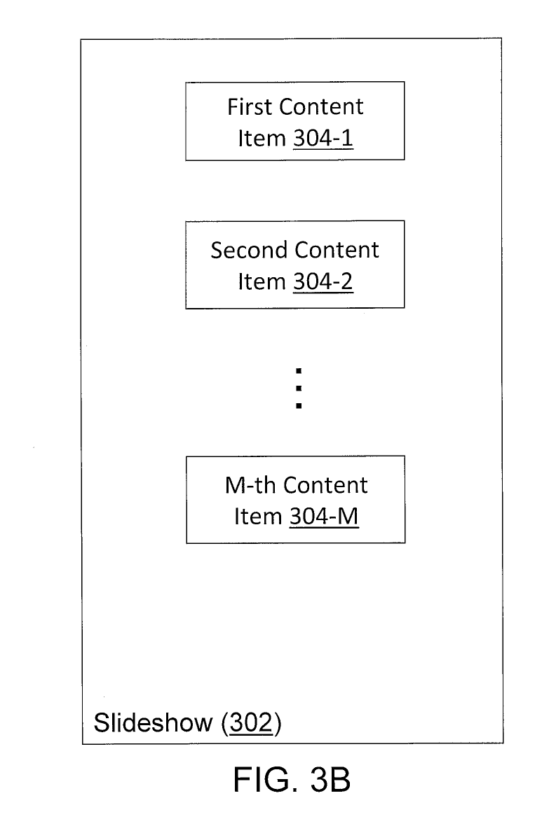

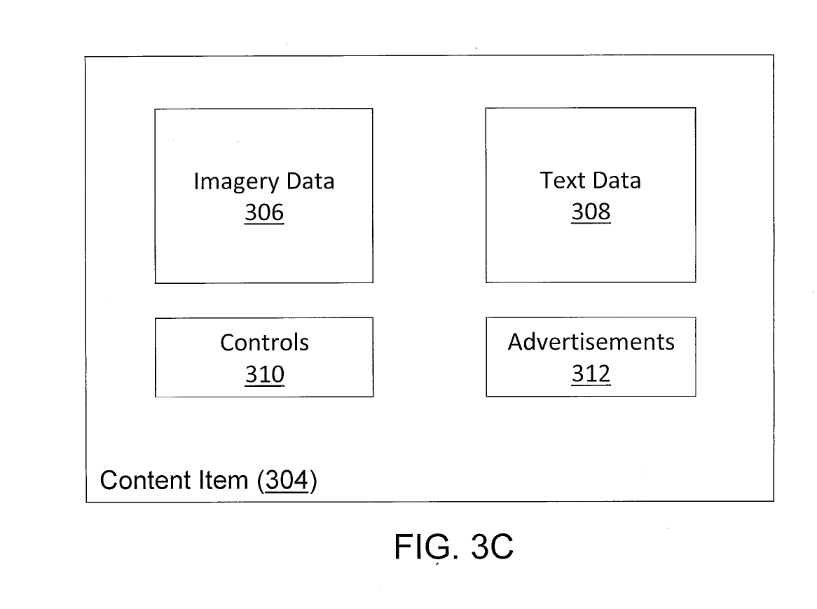

FIG. 3A illustrates an example repository from which slideshows may be accessed by a server (e.g., one of back-end servers 104 in FIG. 1A and FIG. 1B) that directly or indirectly provides content to user, in accordance with an embodiment of the present invention. As illustrated, some user-selectable items, such as 204-1 and 204-3 but not 204-2, are associated with slideshows (for example, 302-1 and 302-2). As used herein, the phrase “a user-selectable item is associated with a slideshow” means that when the user-selectable item is selected by a user, the slideshow is presented to the user. For example, the user-selectable item 1 (204-1) may be presented in a landing page to user 1 (106-1). User 1 (106-1) may click on, mouse over, or otherwise cause an indication of selection, of user-selectable item 1 (204-1) to be sent to the content-providing system 100. This indication of selection of user-selectable item 1 (204-1) may be sent to front-end servers 102. In response, front-end servers 102 may send a request to back-end servers 104 to retrieve slideshow 1 (302-1). The content-providing system 100, or one or more of front-end servers 102 therein, may then provide the retrieved slideshow 1 (302-1) may then be provided to user 1 (106-1) as a response to receiving the indication of selection of user-selectable item 1 (204-1).

FIG. 3B illustrates an example slideshow 302 (e.g., 302-1 or 302-4) that comprises a plurality of content items (e.g., 304-1, 304-2, through 304-M), where M may be any positive integer greater than one (1). For the purpose of illustration, the first content item (304-1) may be chosen as an initial content item (304-1) when slideshow 302 is presented to a user in a client. Through the initial content item (304-1), the user may navigate to other content items in slideshow 302. The user may be given a default navigation order such as a sequential order which may be set based on an order in the rankings of the content items 304. In various embodiments, any navigation order, such as sequential, hierarchical, random, closed loop, etc., may be supported by techniques as described herein. In some embodiments, each content item may be retrieved from first and back-end servers only in response to the user's selection of the content item. In some embodiments, one or more content items, which may not be rendered on the display while another different content item is currently rendered, may have already been preloaded to the client that the user uses to access the content items. In an embodiment, the two or more user-selectable items are continually displayed as the initial content item is displayed and as other content items in the slideshow are navigated to by the user through the controls in any order as described herein.

FIG. 3C illustrates an example content item 304 (e.g., 304-1, 2, through M of FIG. 3B) in accordance with an embodiment of the present invention. The content item 304 may comprise imagery data 306, text data 308, one or more controls 310 and one or more advertisements 312. Imagery data 306 may comprise multimedia data such as audiovisual data, digital pictures, artworks, cartoons, etc. Text data 308 may comprise a caption and a textual passage. The caption and textual passage may be automatically generated. Alternatively and/or additionally, any component in content item 304 such as imagery data 306, caption and textual passage in text data 308, advertisements, etc., may be edited or curated manually. The user may use controls 310 to navigate from one content item to another content item in the slideshow. In some embodiments, one or more of the advertisements (312) may be displayed in a separate display portion from those displaying imagery data 306, text data 308 and controls 310. In some embodiments, one or more of the advertisements (312) may be configured as a content item (304) in the slideshow. For example, as the user navigates from one content item to the next, an interstitial advertisement may appear as one of the content items pre-deposited in the slideshow.

### 5.0 Additional Example Display Pages

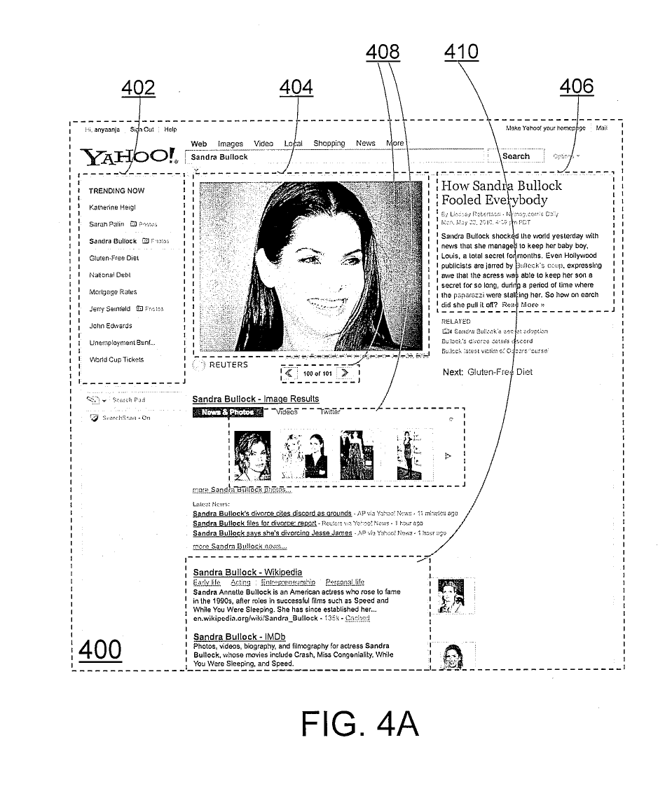

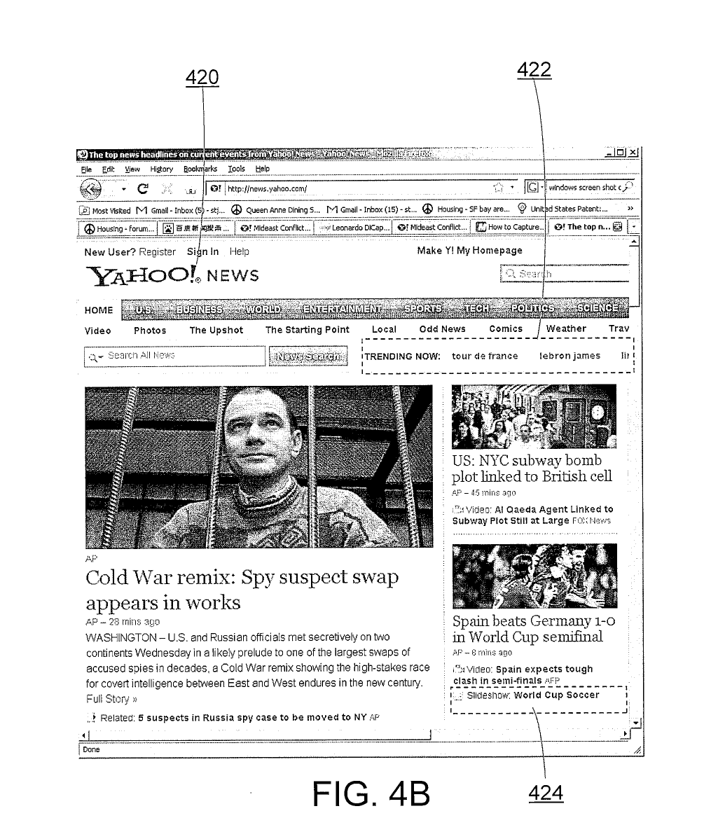

FIG. 4A illustrates an example slideshow display page 400 in accordance with an embodiment of the present invention. Slideshow display page 400 may be called up from a different display page (e.g., a Yahoo! Network or Yahoo! OMG display page) provided by the content-providing system 100. Additionally and/or alternatively, slideshow display page 400 may be called up from a display page provided by an external system that is not a part of the content-providing system 100.

Slideshow display page 400 may comprise a number of display portions. For the purpose of illustration, slideshow display page 400 may comprise a display portion 402 that displays a plurality of user-selectable items (e.g., under a title “Trending Now”), a display portion 404 that displays imagery data of a current content item of a slide show for a user-selectable item in the plurality of user-selectable items, a display portion 406 that displays text data of the current content item of the slide show for the user-selectable item, a display portion 408 that comprises one or more controls to navigate within all content items in the slideshow, and a display portion that displays related search results for the slideshow and/or for the current content item of the slide show.

The content-providing system 100 may provide many different services. In some embodiments, user-selectable items that may lead to slideshows or links to the slideshows may be directly provided on display pages for these different services. FIG. 4B illustrates an example service display page 420 in accordance with an embodiment of the present invention. Service display page 420 provides a news service to users. In some embodiments, the display page (420) may comprise a display portion 422 that comprises a plurality of user-selectable items. Since the user in this example is browsing news stories, personalization engines such as a content optimization knowledge engine (COKE) may be used to select a plurality of user-selectable items to be rendered on the display page. Some of the user-selectable items may be associated with slideshows stored in repository 108. When the user selects one of the user-selectable items, a slideshow display page such as 400 of FIG. 4A may appear for the user to explore.

In some embodiments, the display page (420) may comprise one or more display portions 424 that comprise one or more links to slideshows. For example a link to a slideshow may be directly under or placed next to a photo, an article, etc., on the display page (420). When the user selects one of the links to slideshows, a slideshow display page such as 400 of FIG. 4A may appear for the user to explore one of the slideshows associated with the selected user-selectable item.

### 6.0 Example Process Flow

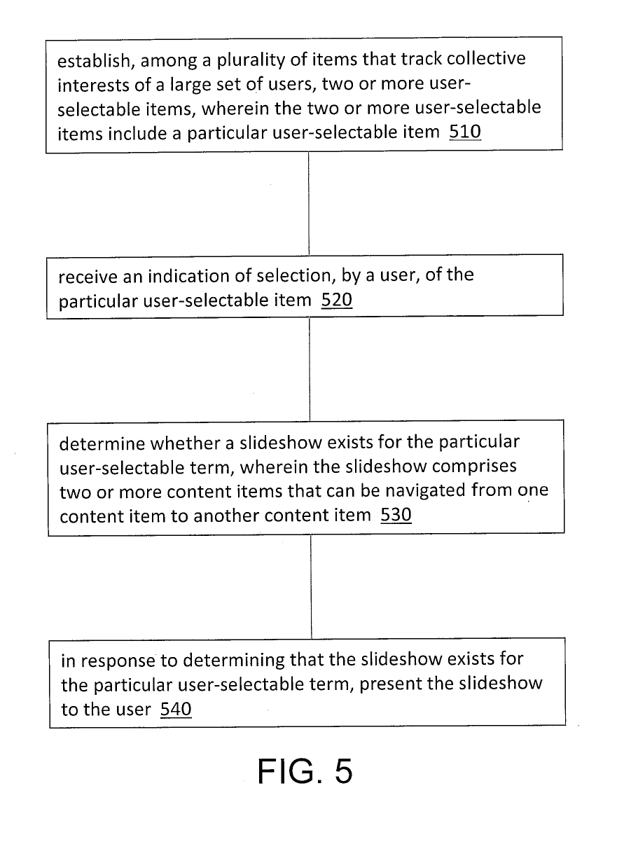

FIG. 5 illustrates one or more example process flows for techniques as described herein. The process flows may be performed by a content-providing system (e.g., system 100) comprising one or more computing devices. Other processes may involve more, fewer, or different steps, arranged in the same or different orders.

In block 510, the content-providing system (100) establishes, among a plurality of items that track collective interests of a large set of users, two or more user-selectable items. The two or more user-selectable items include a particular user-selectable item. In some embodiments, the two or more user-selectable items are selected and ranked for a user based in part on a user profile associated with the user. For example, the user profile may comprise information derived from prior visits by the user.

In block 520, the content-providing system (100) receives an indication of selection, by a user, of the particular user-selectable item.

In block 530, the content-providing system (100) determines whether a slideshow exists for the particular user-selectable term. The slideshow comprises two or more content items, including at least one content item to which a user can navigate from another content item of the two or more content items.

In block 540, the content-providing system (100) presents the slideshow to the user in response to determining that the slideshow exists for the particular user-selectable item, or, in other words, in response to determining that the particular user-selectable item is a slideshow rather than some other non-slideshow type of item.

In an embodiment, to present the slideshow to the user, the content-providing system (100) may cause to be displayed (1) on a first display portion of a first display page, the two or more user-selectable items; (2) on a second display portion of the first display page, imagery data of an initial content item in the slideshow; and (3) on a third display portion of the first display page, a caption and a text passage explaining the imagery data. The content-providing system (100) may also cause to be presented, on the first display page, one or more controls which the user can use to navigate through all content items in the slideshow. In some embodiments, the first display page may be a webpage served by a website, while the two or more user-selectable items are presented as a group of textual terms (e.g., keywords) on the webpage.

In an embodiment, the imagery data displayed in the first display page is one or more of the following: videos, still photographic images, artworks or cartoons.

In some embodiments, the slideshow may be stored in and retrieved from a repository. In some embodiments, any of the users can access the slideshow from a single location using any of two or more services provided by an operator that causes the first display page to be displayed. In some embodiments, external operators, other than the operator that has provided the first display page to the user, also can access the slideshow.

In some embodiments, the slideshow comprises one or more advertisements. In some embodiments, editorial tools are provided to curators or editors of the content-providing system (100). A curator authorized to edit content provided on display pages provided by the content-providing system (100) may edit at least one content item, or information therein, in the slideshow. In some embodiments, the slideshow may be associated with the particular user-selectable item only and is not specifically associated with any user. In some embodiments, the two or more user-selectable items are not inputted by the user.

### 6.0 User Personalization

In an embodiment, the content-providing system 100 utilizes user-specific data to rank re-rank, select, or re-select user-selectable items. Types of user specific data upon which the rankings and selections may be at least partially based include, without limitation, search query histories, content browsing histories, user-identified preferences, and other user behavioral data. Such data may be collected by monitoring user actions using any suitable means, and then stored within a repository. In an embodiment, in addition to or instead of user-specific data, the content-providing system 100 may base rankings at least partially upon similar data specific to a group of users of which the user is a member.

Thus, a landing page requested at the same time by different users may produce different user-selectable items tailored to the individual users or to groups to which the individual users belong. For example, different user-selectable items may be selected as a result of differences in browsing histories for the different users.

In an embodiment, some or all of the user-selectable items and results presented may be personalized based on location-based data, such as an approximate geographic coordinate or region in which the user appears to be located. For example, user-selectable items displayed on a cell phone of a user who is traveling at an airport might differ from user-selectable items the user would see had the user been at her home computer. A variety of mechanisms may be utilized to determine such information, including GPS systems, databases mapping network addresses to general coordinates, user preferences, user input, and so on.

In an embodiment, some or all of the content items in a slideshow may be presented with social sharing controls. For example, each slideshow and/or each content item therein may include a “Share with Friends” button that, when clicked, causes the slideshow and/or the content item, or an article from which the item was derived, to be shared with a group of users. In an embodiment, when a user selects a content item in a slideshow by, for example, clicking on it, the user is brought a page with greater detail about the content item. Meanwhile, the user's selection is logged, and a group of users with which the user is associated may automatically be informed of the user's selection of the content item.

### 8.0 Monetization

In an embodiment, user-selectable items may be ranked at least partially based on monetization factors. For example, a particular user-selectable item or any content therein may be selected over another user-selectable item because the particular user-selectable item will bring an operator of the content-providing system more traffic and thus more revenue. Or, a user-selectable item or any content therein may be selected over another user-selectable item because an advertiser has arranged to pay the operator a certain amount of money in exchange for brining certain amount of traffic to an advertisement. In an embodiment, various advertisers may have been guaranteed a certain amount of traffic to an advertisement. Ranking processes may therefore attempt to balance selection of user-selectable items so that the commitment to each advertiser is fulfilled.

### 9.0 Time Sensitivity

In an embodiment, one or more factors for selecting and ranking user-selectable items or candidate user-selectable items may be time-sensitive. For example, various selecting and ranking features may be based on collected data that is updated over time. For example, occurrences or frequencies of user-selectable items in collective browsing and searching activities of a large set of users may be weighted so that more recent occurrences and/or more frequency of the user-selectable item are given greater significance.

Accordingly, in an embodiment, different ranking may be generated for a user-selectable item at different times. Furthermore, in some embodiments, the content of a slideshow for the user-selectable item may be constant. In alternative embodiments, the content of a slideshow for the same user-selectable item may change from time to time. Not only may content items in the slideshow change, but also advertisements, the number of content items, and the overall organization of the information in the slideshow may change.

### 10.0 Implementation Mechanism—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

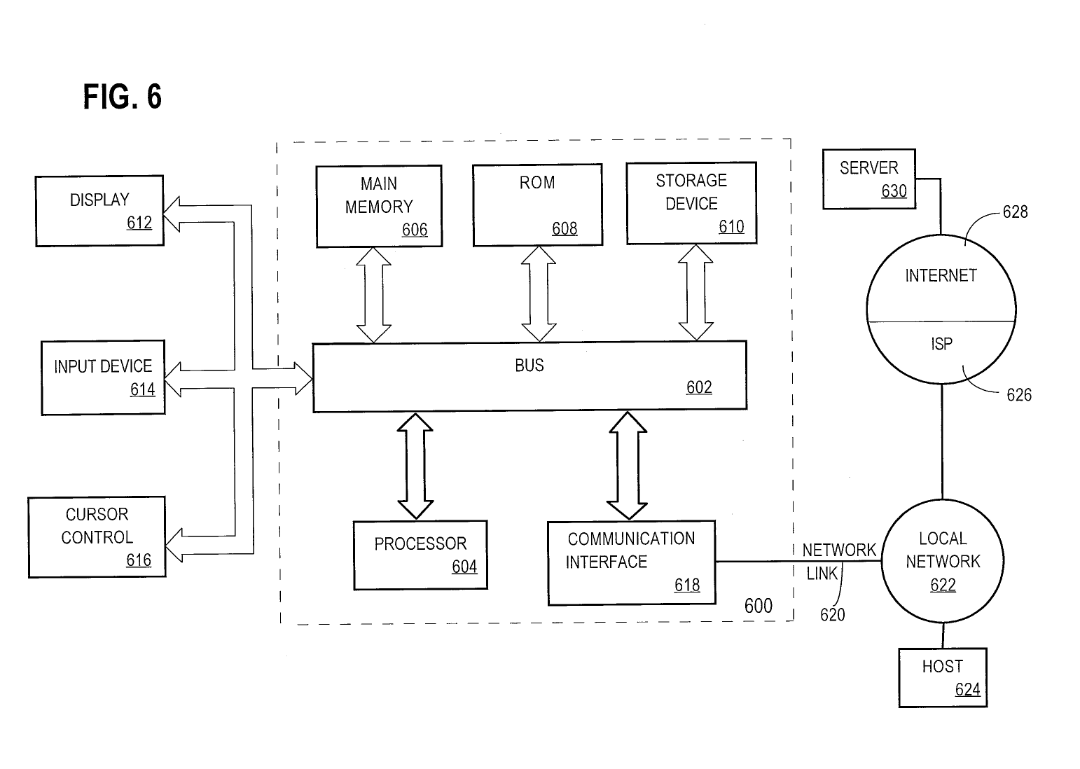

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11.0 Extensions and Alternatives

As used herein, the term “server” is not limited to a single server component executing at a single computing device, but may also refer to multiple server components that execute at multiple computing devices to collectively provide the functionality described as being provided by the server. Likewise, the term “component” may refer to, for example, a single instance of instructions being executed at a single computing device, or multiple instances of instructions executing at multiple computing devices.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
establishing, among a plurality of items that track collective interests of a set of users, two or more user-selectable items, wherein the two or more user-selectable items include a particular user-selectable item;
receiving an indication of selection, by a user, of the particular user-selectable item;
determining whether a slideshow exists for the particular user-selectable term, wherein the slideshow comprises two or more content items, including at least one content item to which the user can navigate from another content item of the two or more content items; and
in response to determining that the slideshow exists for the particular user-selectable term, presenting the slideshow to the user;
wherein the method is performed by one or more computing devices.

2. The method of claim 1, wherein presenting the slideshow to the user includes:
causing the two or more user-selectable items to be displayed on a first display portion of a first display page;
causing imagery data of an initial content item in the slideshow to be displayed on a second display portion of the first display page;
causing a caption and a text passage explaining the imagery data to be displayed on a third display portion of the first display page; and
causing one or more controls, which the user can use to navigate through all content items in the slideshow, to be presented.

3. The method of claim 2, wherein the imagery data is one or more of videos, still photographic images, artworks or cartoons.

4. The method of claim 1, wherein the first display page is a webpage served by a website and wherein the two or more user-selectable items are presented as a group of textual terms on the webpage.

5. The method of claim 1, wherein the two or more user-selectable items are selected and ranked for a user based in part on a user profile associated with the user;

6. The method of claim 5, wherein the user profile comprises information derived from prior visits to webpages by the user.

7. The method of claim 1, wherein the slideshow is stored in a repository and wherein the slideshow can be accessed by any of the users using any of two or more services provided by an operator that causes the first display page to be displayed.

8. The method of claim 1, wherein the slideshow is stored in a repository and wherein the slideshow can be accessed by an external operator that has not displayed the first display page to the user.

9. The method of claim 1, wherein the slideshow comprises one or more advertisements.

10. The method of claim 1, wherein at least one content item, or information therein, in the slideshow is edited by a curator and wherein the curator is authorized to edit content provided on display pages of an operator that causes the first display page to be displayed to the user.

11. The method of claim 1, wherein the slideshow is associated with the particular user-selectable item only and is not specifically associated with any user.

12. The method of claim 1, wherein the two or more user-selectable items are not inputted by the user.

13. One or more non-transitory computer-readable media storing instructions that, when executed by one or more computing devices, cause performance of the method of claim 1.

14. One or more non-transitory computer-readable media storing instructions that, when executed by one or more computing devices, cause performance of the method of claim 2.

15. One or more non-transitory computer-readable media storing instructions that, when executed by one or more computing devices, cause performance of the method of claim 3.

16. One or more non-transitory computer-readable media storing instructions that, when executed by one or more computing devices, cause performance of the method of claim 4.

17. One or more non-transitory computer-readable media storing instructions that, when executed by one or more computing devices, cause performance of the method of claim 5.

18. One or more non-transitory computer-readable media storing instructions that, when executed by one or more computing devices, cause performance of the method of claim 6.

19. One or more non-transitory computer-readable media storing instructions that, when executed by one or more computing devices, cause performance of the method of claim 7.

20. One or more non-transitory computer-readable media storing instructions that, when executed by one or more computing devices, cause performance of the method of claim 8.

21. One or more non-transitory computer-readable media storing instructions that, when executed by one or more computing devices, cause performance of the method of claim 9.

22. One or more non-transitory computer-readable media storing instructions that, when executed by one or more computing devices, cause performance of the method of claim 10.

23. One or more non-transitory computer-readable media storing instructions that, when executed by one or more computing devices, cause performance of the method of claim 11.

24. One or more non-transitory computer-readable media storing instructions that, when executed by one or more computing devices, cause performance of the method of claim 12.

25. A system comprising:
front-end servers executing on a first set of one or more computing devices;
back-end servers executing on a second set of one or more computing devices;
wherein the front-end servers provide display pages to users;
wherein the back-end servers provide content to the front-end servers upon request;
wherein the front-end servers establish, among a plurality of items that track collective interests of a large set of users, two or more user-selectable items, wherein the two or more user-selectable items include a particular user-selectable item;
wherein the front-end servers receive an indication of selection, by a user, of the particular user-selectable item;
wherein the front-end servers determine whether a slideshow exists for the particular user-selectable term, wherein the slideshow comprises two or more content items, including at least one content item to which the user can navigate from another content item of the two or more content items; and
wherein the front-end servers in response to determining that the slideshow exists for the particular user-selectable term, present the slideshow to the user.

26. An apparatus comprising one or more computer devices, wherein the apparatus:
establishes, among a plurality of items that track collective interests of a large set of users, two or more user-selectable items, wherein the two or more user-selectable items include a particular user-selectable item;
receives an indication of selection, by a user, of the particular user-selectable item;
determines whether a slideshow exists for the particular user-selectable term, wherein the slideshow comprises two or more content items, including at least one content item to which the user can navigate from another content item of the two or more content items; and
presents the slideshow to the user in response to determining that the slideshow exists for the particular user-selectable term.
